(19) United States
(12) Patent Application Publication
(10) Pub. No.: US 2026/0106523 A1
(43) Pub. Date: Apr. 16, 2026

(54) Additively Manufactured Magnetic Plate, Laminated Core, and Electric Machine

(71) Applicant: Siemens Aktiengesellschaft, München (DE)

(72) Inventors: Carsten Schuh, Baldham (DE); Rolf Vollmer, Gersfeld (DE)

(73) Assignee: Siemens Aktiengesellschaft, München (DE)

(21) Appl. No.: 19/114,107

(22) PCT Filed: Aug. 29, 2023
(86) PCT No.: PCT/EP2023/073589

§ 371 Date: Mar. 21, 2025

(30) Foreign Application Priority Data
Sep. 23, 2022 (EP) 22197424.9

(51) Int. Cl. H02K 15/0273; B33Y 80/00; C22C 38/40; H02K 1/02; H02K 1/22

(52) U.S. Cl. CPC H02K 15/0273; B33Y 80/00; C22C 38/40; H02K 1/02; H02K 1/22; C22C 2202/02

(57) ABSTRACT

Various embodiments of the teachings herein include an additively manufactured rotationally symmetric magnetic lamination for a laminated core of an electric machine. An example includes: a first material component and a second material component separate from one another in their planar extent; wherein the material components meet at an interface forming a boundary line when viewed at right angles to a plane of the lamination; material depression lines in the magnetic lamination run from the first material component over the boundary line to the second material component; and the running angle a thereof, based on the tangent of the boundary line at which the material depression line intersects the boundary line, is between 45° and 135°.

### CROSS-REFERENCE TO RELATED APPLICATIONS

This application is a U.S. National Stage Application of International Application No. PCT/EP2023/073589 filed Aug. 29, 2023, which designates the United States of America, and claims priority to EP Application No. 22197424.9 filed Sep. 23, 2022, the contents of which are hereby incorporated by reference in their entirety.

### TECHNICAL FIELD

The invention relates to additive manufacturing. Various embodiments of the teachings herein include additively manufactured magnetic laminations, laminated cores, and processes for producing an electric machine.

### BACKGROUND

Screen printing or stencil printing may be used for producing magnetic laminations for electric machines. This comprises printing a printing paste onto a substrate using a stencil, the open regions of which may also be provided with a screen. Stencil printing is an umbrella term covering screen printing. In addition to solvents and/or binders, the printing paste contains metal powders, which have a functional action in the resulting component. The screen printing technique results in production of a green body, which after a further heat treatment is firstly generally debindered and then fed to a sintering process at a higher temperature. The metallic powder grains are sintered to one another such that a structured lamination, the magnetic lamination, is produced.

To achieve a higher mechanical strength of such laminations, in particular in the case of high rotor speeds in electric machines, the producibility of two-component magnetic laminations is becoming increasingly important. One example of this is described in EP 3723249 A1. Further examples include EP 3 629 453 A1, EP 3 932 591 A1 and EP 3 725 435 A1. A fundamental problem with such two-component magnetic laminations produced by the stencil printing method is that the different materials, if they have good magnetic properties on the one hand and have high strength on the other hand, generally have different coefficients of thermal expansion. For example, a high-strength steel that constitutes a subcomponent in respect of the mechanical strength of the magnetic lamination thus has a coefficient of expansion of 16×10⁻⁶ K⁻¹. A further soft-magnetic material in this respect has a coefficient of thermal expansion of between 10-12×10⁻⁶ K⁻¹ in a temperature range between 0 and 100° C. During the joint sintering of such different material components, or material pairs, in a green body to afford a magnetic lamination, high mechanical stresses arise in the connecting regions or seam regions between these material components owing to these different coefficients of thermal expansion, in particular when the sintering temperatures are being cooled down to room temperature. This can lead to deformations or to cracks or overall to mechanical stresses in the magnetic lamination which can significantly impair the mechanical or magnetic properties.

### SUMMARY

Teachings of the present disclosure provide a magnetic lamination used to generate a laminated core and an electric machine, where the magnetic lamination has a higher strength and lower intrinsic stresses compared to the prior art when using at least two material components within the magnetic lamination. For example, some embodiments include an additively manufactured rotationally symmetric magnetic lamination (2) for a laminated core (4) of an electric machine (6), where there are at least two material components (8, 10) that are separate from one another in their planar extent, a first material component (8) and a second material component (10), where the material components (8, 10) meet at an interface (12) that forms a boundary line (14) when viewed at right angles to the plane of the lamination, characterized in that material depression lines (16) have been introduced into the magnetic lamination (2) and run from the first material component (8) over the boundary line (14) to the second material component (10), and the running angle a thereof, based on the tangent (18) of the boundary line (14) at which the material depression line (16) intersects the boundary line (14), is between 45°and 135°. In some embodiments, material elevation lines (20) have been introduced into the magnetic lamination (2) and extent from the first material component (8) over the boundary line (14) to the second material component (10), and the running angle α′ thereof, based on the tangent (18) of the boundary line (14) at which the material elevation line (20) intersects the boundary line (14), is between 45° and 135°.

In some embodiments, material depression lines (16) have varying depths.

In some embodiments, the material depression lines (16) have a length between 1 mm and 10 mm.

In some embodiments, the boundary line (14) is formed by one material component (8, 10) such that it forms an undercut in the other material component (8, 10).

In some embodiments, the course of the boundary line (14) is of rotationally symmetric configuration with respect to a center axis (22) of the magnetic lamination (2).

In some embodiments, the first material component (8) comprises an iron alloy which has an austenitic microstructure to an extent of at least 25% by volume.

In some embodiments, the second material component (10) comprises an iron alloy comprising at least 90% by weight, especially at least 96% by weight, of iron.

In some embodiments, the second material component (10) has a ferritic or martensitic microstructure.

In some embodiments, the first material component (8) is a chromium-nickel alloy.

In some embodiments, the first material component (8) is an iron-chromium alloy, with a chromium content of between 22% by weight and 28% by weight, in particular between 24% by weight and 26% by weight.

In some embodiments, the first material component (8) has a nickel content of between 4% by weight and 10% by weight, in particular between 6% by weight and 8% by weight.

As another example, some embodiments include a laminated core for a rotor (24) of an electric machine (6), comprising a plurality of magnetic laminations (2) as described herein.

In some embodiments, the magnetic laminations (2) are stacked in such a way that material depression lines (16) of a first magnetic lamination (2) are filled by material elevation lines (20) of a second magnetic lamination (2′).

As another example, some embodiments include an electric machine comprising a laminated core (4) as described herein.

### BRIEF DESCRIPTION OF THE DRAWINGS

Further embodiments of the teachings herein and further features are explained in detail with reference to the figures that follow. The figures are purely schematic illustrations that do not constitute any restriction of the scope of this disclosure. Features that have the same designation but appear in different embodiments are each given the same reference numeral. The figures show:

FIG. 1 a three-dimensional exploded diagram of a typical electric machine;

FIG. 2 a laminated core comprising a multitude of two-component magnetic laminations incorporating teachings of the present disclosure;

FIG. 3 a top view of a two-component magnetic lamination incorporating teachings of the present disclosure similar to the configuration in FIG. 2;

FIG. 4a an enlarged detail from FIG. 3;

FIG. 4b an enlargement of the dotted box IV b;

FIG. 4c a cross-sectional diagram in schematic form along the line IV c;

FIGS. 5a, 5b an analogous diagram as in FIG. 4b, c with alternative configuration forms, ;

FIGS. 6a, 6b an alternative configuration form to FIG. 5;

FIGS. 7a, 7b a further alternative configuration form to FIG. 6 with undercuts between the first and second material components;

FIG. 8 a schematic diagram of a possible stack sequence of cross sections of different magnetic laminations; and

FIGS. 9a, 9b, 9c a schematic diagram of a production process for production of a two-component magnetic lamination incorporating teachings of the present disclosure.

### DETAILED DESCRIPTION

The teachings of the present disclosure include additively manufactured rotationally symmetric magnetic laminations for a laminated core of an electric machine. In general, there are at least two material components that are separate from one another in their planar extent. These are a first material component and a second material component. The two material components meet at an interface that forms a boundary line when viewed at right angles to the plane of the lamination. Material depression lines have been introduced into the magnetic lamination and run from the first material component over the boundary line to the second material component. A running angle is defined here for the running of the material depression lines, which is oriented to a tangent of the boundary line, specifically the tangent at the point where the material depression line intersects the boundary line. This angle a with regard to the tangent is at least 45° and at most 135°.

The highest stresses occur in a two-component magnetic lamination, these originating from the different coefficients of expansion of the individual components, especially on cooling from the sintered phase. Thermal stresses also arise during operation of the electric machine as a result of elevated operating temperatures, but it is the cooling process in the course of production, i.e., in the sintering of the magnetic lamination, that leads to the highest thermal stresses. In order to reduce or even to avoid these, the material depression lines described are introduced into the magnetic lamination such that they run across the boundary line between the individual material components.

Zones are thus created, in which, given an originally defined stress state-which is caused by the change in temperature or by the cooling process owing to the different coefficients of thermal expansion-the associated real, i.e. absolute, elongations are greater or less according to coefficients of expansion. The effect of this is that, on average, the residual average stress state can be reduced compared to the unstructured transition regions. The effect of these structuring operations by means of material depression lines in the transition region between material components can therefore be compared with a spring element from mechanical engineering.

The material depression lines may run virtually at right angles to the tangent at the point of intersection of the material depression line with the boundary line. According to the course of the boundary line, however, variances from this perpendicular progression to the tangent may be appropriate. These variances, with regard to the perpendicular progression, i.e. the 90° progression to the tangent, are between 45° and 135° based on the tangent.

The expression “material depression line” generally means a line having a relatively high aspect ratio, typically greater than five, but it does not have to be an exactly drawn line. It is also possible for a rounded, oval course or a zigzag shape along its extent to be appropriate here when the boundary line is crossed. The cross section of the material depression line also need not be exactly rectangular; here too, rounded or rectangular cross sections, or cross sections that are quite rectangular in their area ratio, may be appropriate. It should be noted here that, in the case of magnetic laminations, which typically have a thickness of 100 to 200 μm, owing to process-related tolerances, concessions have to be made in any case to the accuracies in the drawing of a defined cross section or a particular length and width of the line.

The material depression lines may have been produced entirely by stamping the magnetic lamination, but they may also have been scored or milled, or be depressions made by deformation.

The exact number of material depression lines, the density thereof along the boundary line, the length thereof, the alignment thereof based on the described tangent to the boundary line and the cross-sectional structuring thereof may depend on the material components employed and hence on the coefficients of expansion thereof. In addition, these parameters are also influenced by the layout, i.e. the design, of the magnetic lamination. In some embodiments, the material depression lines have a length between 1 mm and 10 mm. The depth of the material depression lines, as described, is between complete stamping and 10 percent erosion, such that this size in particular depends on the described circumstances, layout and material components. In some embodiments, the distance between the material depression lines or the material elevation lines is less than or equal to their length. If the length, for example, is 5 mm, the distance may be between 0.5 mm and 5 mm.

In order to exactly determine these described parameters for the magnetic lamination respectively used, in the construction of the magnetic lamination, with knowledge of the coefficients of thermal expansion of the material components used and with knowledge of the magnetically and mechanically optimized layout, by means of a standard finite element method at the boundary lines, the number, the density and the configuration of the material depression lines is determined accurately, such that these can be correspondingly introduced in the production process according to the finite element calculation.

However, the positive effect of the material depression lines, and the fact that the absolute expansion of the materials is lower along this weakened region and hence thermal stresses are dissipated, or do not even occur, is also accompanied by a negative effect, namely weakening of the material in the region of the boundary line. The introduction of the material depression lines is thus a compromise between the increase in the strength owing to the reduction in the thermal stresses and simultaneously occurring material weakening. However, the adverse effect of the material weakening is much smaller than the positive effect of the stress reduction. This compromise is an optimization task which can likewise be accomplished by the described method using the finite element method.

A further means of specifically avoiding this material weakening is simultaneous material elevation, i.e., the introduction of material elevation lines that are aligned analogously to the material depression lines. They likewise cross the boundary line and have the same angle a, referred to as α′, based on the tangent, which is between 45° and 135°.

These material elevation lines, which can be created, for example, by application of material or else by deforming embossment from the opposite side of the magnetic lamination, will be discussed in particular in the assembly of the overall laminated core from individual magnetic laminations. To wit, it is appropriate for material elevation lines of a magnetic lamination to mesh into material depression lines of a magnetic lamination that follows in the stack of magnetic laminations of the laminated core. Thus, the material weakening at this site is compensated for, and the effect of the material depression lines with regard to the coefficient of thermal expansion is maintained. In order to prevent bending or deformation of such magnetic laminations on sintering and in operation, a rotationally symmetric design of the magnetic lamination, especially of a transition region along the boundary line with regard to a center axis of the magnetic lamination, is advantageous. The center axis of the magnetic lamination also coincides here with an axis of rotation of a rotor containing the later laminated core. What is meant here by rotationally symmetric is point symmetry of a radius with regard to a center, in a rotor with regard to the point of intersection of the center axis.

In some embodiments, the boundary line through a material component is formed such that it forms an undercut in the other material component. However, this undercut should be made only through one material component into the respectively other material component and should not alternate. In some embodiments, the material component having the higher coefficient of thermal expansion forms the undercut in the material component having the low coefficient of expansion, since this results in an attraction process between the components. If there were undercuts on both sides, there would be mutual hindrance of the attraction process, possibly causing further stresses.

As described, the magnetic lamination comprises at least two different material components which differ especially in their mechanical and magnetic properties. This makes it possible to specifically focus on the technical properties required in certain regions of the magnetic lamination. The first material component therefore comprises an iron alloy which comprises an austenitic microstructure to an extent of at least 25% by volume. This austenitic microstructure which is achievable especially through highly alloyed steels has a very high strength, especially tensile and flexural strength.

By contrast, the second material component comprises an iron alloy comprising at least 95% by weight, especially at least 97% by weight, of iron. In some embodiments, the second material component is pure iron, which has especially good magnetic properties, especially soft-magnetic properties, and which is very readily remagnetizable through hysteresis. It should be noted that the figures relating to the austenitic microstructure are specified in % by volume and the figures relating to alloying are specified in % by weight. This is because microstructures can be more easily specified microscopically in microsections in % by volume, and the alloy constituents are reported hereinafter in % by weight, which is customary in the art and constitutes unambiguous manufacturing instructions in the composition of an alloy.

In some embodiments, the second material component which has very good soft-magnetic properties in turn has a ferritic and/or martensitic microstructure.

In some embodiments, the first material component, which has the high mechanical strength and ensures the strength of the overall magnetic lamination during rotational motion, is in turn an iron-chromium-nickel alloy. In some embodiments, this in turn has a chromium content of between 22% by weight and 28% by weight, especially between 24% by weight and 26% by weight. Moreover, the nickel content of the described iron-chromium-nickel alloy has a proportion of between 4% by weight and 10% by weight, especially between 6% by weight and 8% by weight.

In some embodiments, a laminated core for a rotor of an electric machine comprises a multitude of magnetic laminations as described herein. In some embodiments, the magnetic laminations of the laminated core are stacked in such a way that material depression lines of one magnetic lamination are filled by material elevation lines of a second magnetic lamination. This firstly increases the fill factor of the laminated core with magnetically active material, especially the material of the second material component, and reduces the weakening of the magnetic lamination that occurs as a result of introduction of the material depression lines at the boundary line.

In some embodiments, an electric machine comprises a laminated core as described herein. Such an electric machine has the advantages brought by the introduction of a high-strength magnetic lamination, which are in particular that it brings the magnetic properties of the magnetic lamination thus created or of the resulting laminated core. The electric machine may especially be an electric motor or a generator.

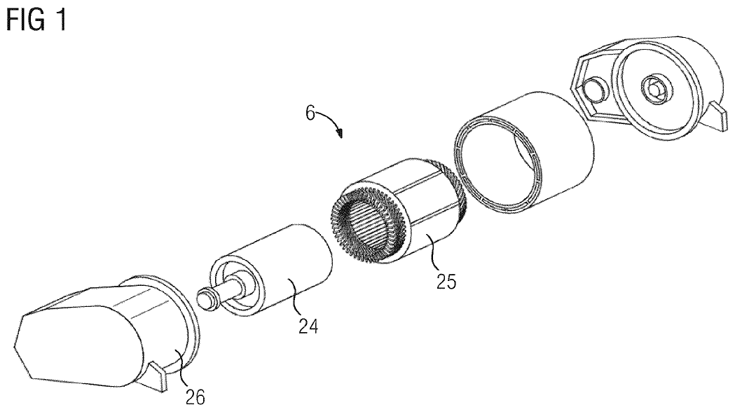

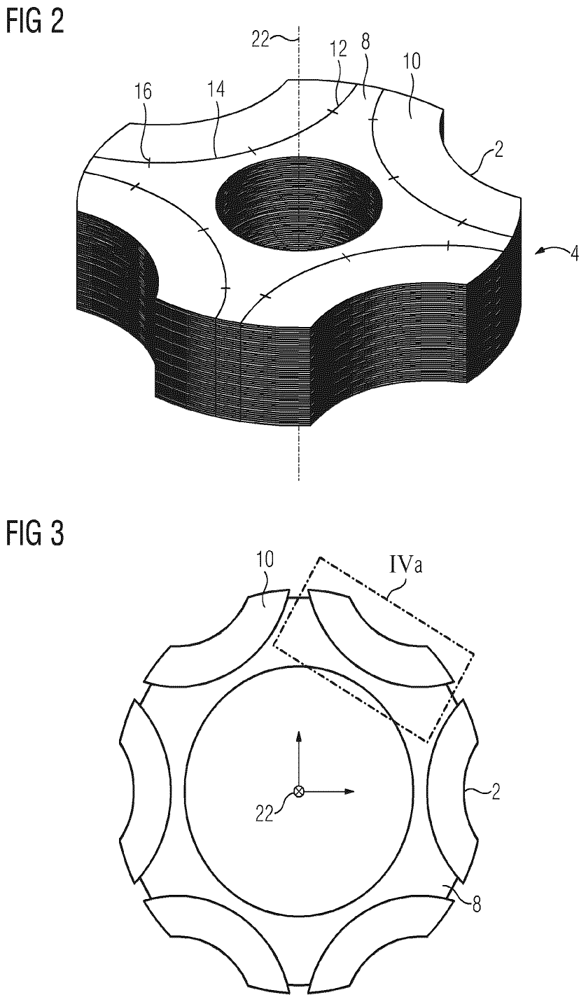

For better classification of the described magnetic lamination 2, FIG. 1 firstly shows an exploded diagram of an electric machine 6. This comprises a rotor 24 and a stator 25 which are surrounded by a housing 26. The electric machine 6 may be an electric motor or a generator. The rotor 24 in turn comprises a laminated core 4 not shown explicitly in FIG. 1, around which electrically conductive wires are wound in a particular manner as coils. Such a laminated core 4 is shown by way of example in FIG. 2. The laminated core 4 according to FIG. 2 comprises a stack of a multiplicity of magnetic laminations 2, wherein the layout of the magnetic lamination 2 is configured such that there are correspondingly cutouts and grooves for the conductor winding.

The magnetic laminations 2 that are stacked in FIG. 2 to form a laminated core 4 have two material components 8, 10. A first material component 8 comprises a highly alloyed, high-strength steel, e.g. based on an iron-chromium-nickel alloy. The first material component 8 is crucial for the strength of the laminated core 2. By contrast, the second material component 10 has soft-magnetic properties in particular and shows particularly good remagnetizability. In some embodiments, it comprises pure iron, which has particularly good soft-magnetic properties. The iron content of the second material component 10 may be at least 97%, and the microstructure of the second material component 10 generally has a ferritic or martensitic microstructure. By contrast, the microstructure of the first material component 8 may have austenitic structures.

In addition, in the uppermost magnetic lamination 2 of the laminated core 4, material depression lines 16 are indicated along a boundary line 14 between the first material component 8 and the second material component 10, and these will be discussed in detail in the next figures.

FIG. 3 gives a top view of a similar magnetic lamination 2, as already shown in FIG. 2 with reference to the laminated core 4. Here too, there are two material components 8, 10: the first material component 8 having the high mechanical strengths and the second material component 10 having the good soft-magnetic properties. The layout of the magnetic lamination 2 in FIG. 3 differs from that in FIG. 2 in that, rather than four regions having soft-magnetic material components 10, six of these regions are provided here. However, what the two magnetic laminations 2 in FIGS. 2 and 3 have in common is rotational symmetry with regard to a center axis 22, which also coincides with a rotor axis of the electric machine according to FIG. 1.

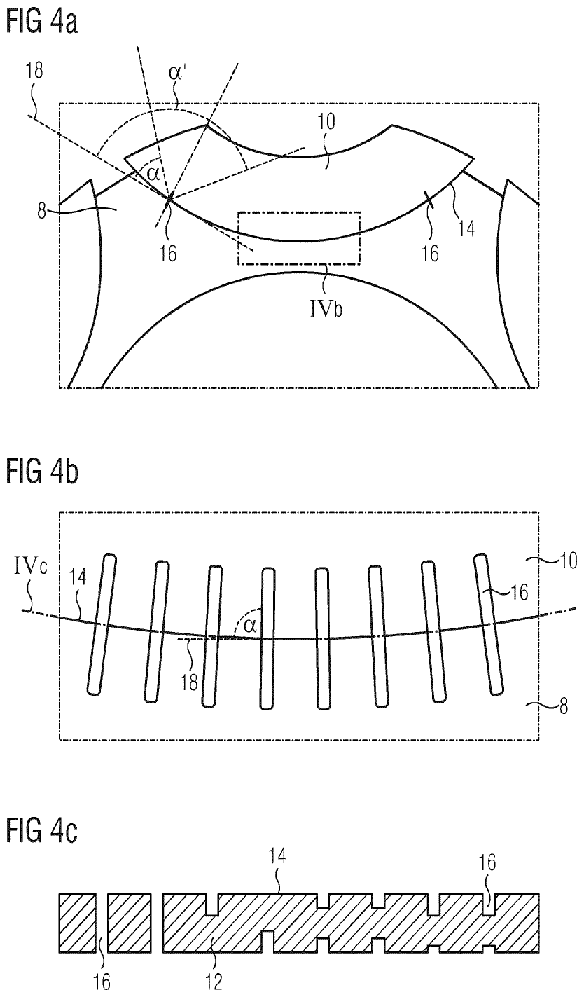

FIG. 4a shows an enlarged diagram of the detail IV a from FIG. 3. This shows material depression lines 16 by way of example, which are further illustrated in a further enlarged detail in FIG. 4b. FIG. 4c in turn shows a cross section along the line IV c in FIG. 4b.

The first material component 8 and the second material component 10 when viewing a cross section as in FIG. 4 c, meet at an interface 12. In reality, the interface 12, owing to process-related tolerances and circumstances, is generally not an absolute discrete interface 12; instead, it is a transition region where material diffusion processes take place owing to the sintering process and hence form the described transition region. In a top view of the magnetic lamination, however, a boundary line 14 is formed, which runs along the interface 12 between the two material components 8, 10. These boundary lines 14 are crossed by material depression lines 16 that run from the first material component 8 to the second material component 10 across the boundary line 14. For definition of the course of the boundary lines 16, a tangent 18 is first defined, at the point where the material depression line 16 intersects the boundary line 14. The course of the material depression line 16 is generally perpendicular with regard to the tangent 18. However, it may also, as shown in FIG. 4a, form an angle α with the tangent 18 of between 45° and 135°. In some embodiments, the angle α is between 85° and 95° with respect to the tangent 18.

There follows a discussion of the effect of the material depression line and the configuration thereof. FIG. 4b shows a multitude of material depression lines 16, which run essentially perpendicular to the tangent 18 here too, such that the angle a is about 90°. The material depression lines 16 according to FIG. 4b may be holes punched through the magnetic lamination 2, as apparent, for example, on the left in FIG. 4c from the cross-sectional diagram along the line IV c in FIG. 4b. On the other hand, the material depression lines 16 may also be partial notches, as likewise shown in FIG. 4c.

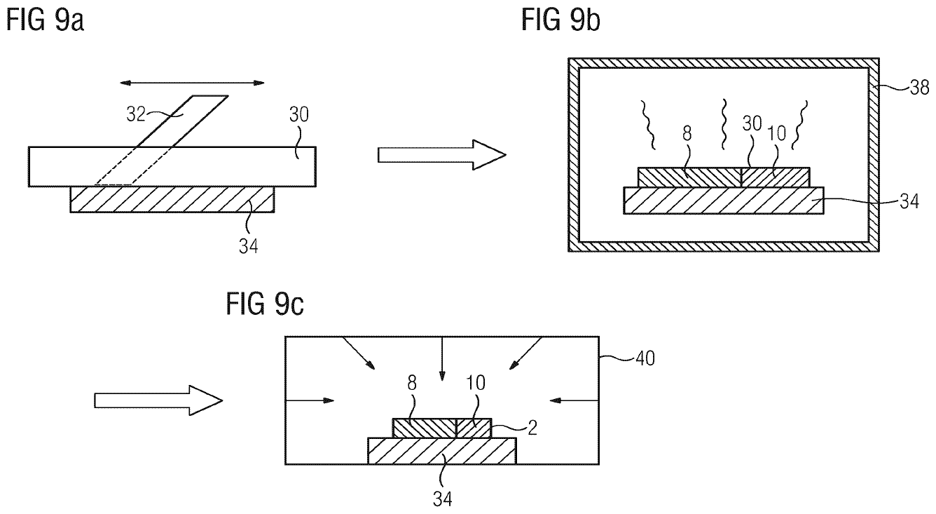

The production technique for the magnetic lamination 2 comprising the two material components 8 and 10 is to be discussed in detail according to FIG. 9. The magnetic lamination 2 is described here as a sintered metal lamination having two components 8, 10. When this sintered two-component lamination 2 is cooled, because of the different coefficients of thermal expansion of the two material components 8, 10, thermomechanical stresses are induced in the interface 12 along the boundary line 14. By virtue of the material depression lines inserted, there is now a lower material density at the boundary line 14, which also leads to different absolute expansions of the material in this region. The thermomechanical stresses that occur are thus at least partly compensated for by the material depression lines 16, analogously to a spring element.

The material depression lines according to FIG. 4b and c are shown here as straight lines with a rectangular cross section. This is a simplified diagram, which may be configured differently in practice according to the coefficient of expansion of the individual material components 8, 10 and according to the layout of the magnetic lamination 2. For exact calculation of the shape and the progression and of the length and the depth of the material depression lines 16, preference is given to using a calculation method by means of a finite element method based on the different parameters, i.e. the coefficients of expansion and the layout, of the magnetic lamination 2.

The two material components 8, 10 have different technical properties. In some embodiments, the first material component comprises a highly alloyed chromium-nickel steel which may comprise more than 25 percent by volume of austenitic microstructure. For example, the chromium content here is 25 percent by weight and the nickel content is 7 percent by weight. An example alloy is a stainless steel alloy having a very high strength. As apparent in FIGS. 2 and 3, the first material component is positioned centrally within the magnetic lamination 2 and hence, on rotational motion on the rotor 24, bears the highest tensile stress acting on the magnetic lamination 2 or on the laminated core 4 formed therefrom.

By contrast, the material properties of the second material component 10 are aligned in particular to the magnetic properties. In some embodiments, the material of the second material component 10 is formed from pure iron and has a ferritic and martensitic microstructure. Pure iron has the best soft-magnetic properties and is easy to repolarize in this regard. This is important for AC motors or generators.

Although they are generally constructed from iron alloys, the two different material components 8, 10 exhibit a certain difference in their coefficient of electrical expansion. Depending on the alloy composition, the coefficient of expansion between the individual iron alloys may be between 10×10⁻⁶ K⁻¹ and 20×10⁻⁶ K⁻¹ for example. In addition, a temperature increase from room temperature to 200° C., which in some cases may be the operating temperature of an electric high-performance machine at high rotational speeds, can likewise lead to a change in the coefficient of expansion by 10×10⁻⁶ K⁻¹. This difference between the individual coefficients of expansion depending on the material composition, but also depending on the operating temperature range of the machine, leads to considerable thermomechanical stresses at the interface 12 or along the boundary line 14 between the individual material components 8 and 10. Further high thermomechanical stresses, as already mentioned, occur on cooling from the requisite sintering temperatures.

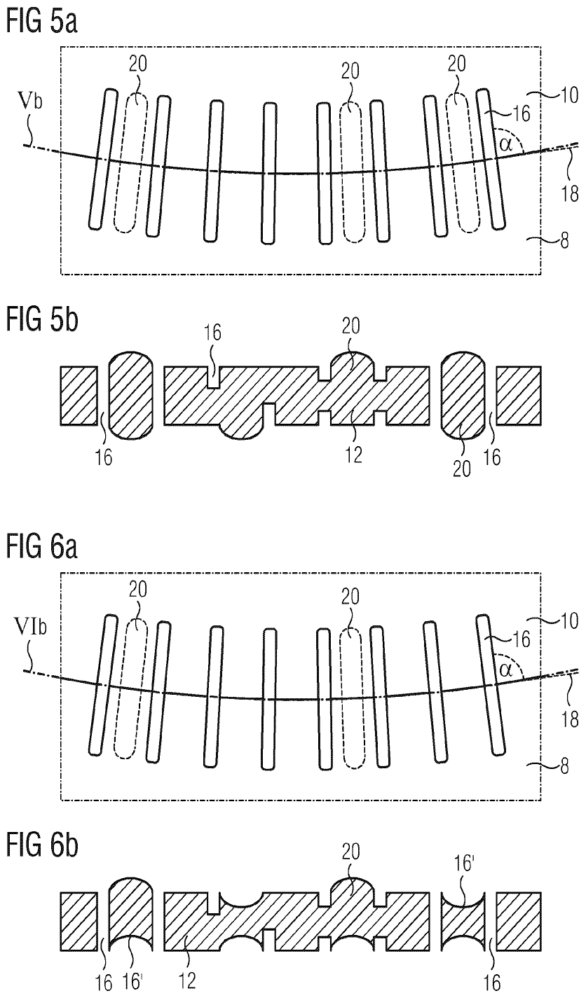

FIGS. 5 and 6 give analogous illustrations to FIG. 4b and c. FIGS. 5a and 6a again give a top view of a corresponding detail along a boundary line 14 between the two material components 8, 10. Also shown are material elevation lines 20, which are likewise apparent in the corresponding cross-sectional diagrams according to FIGS. 5b and 6b. The material elevation lines 20 may serve to compensate for material weakeness caused by the material depression lines 16. The possibility for compensation is addressed in FIG. 8.

FIG. 8 shows a stack sequence of magnetic laminations 2, where material elevation lines 20 and material depression lines 16 are complementary in such a way that a material elevation line 20 of a first magnetic lamination 2 is inserted into a material depression line 16 of a second magnetic lamination 2 on stacking to give a laminated core 4. In this way, there is both an increase in the filling level of the laminated core 4 and compensation for mechanical weakening that may be caused by a material depression line 16. FIGS. 5 and 6 show further possible cross sections for material depression lines 16, which are identified there as 16′. These, shown in schematic form, are curved depressions that are an alternative form to the rectangular depressions as shown in FIG. 4c. What kind of material depression lines 16 are chosen depends on optimization calculations that can be conducted, for example, by the finite element method already described.

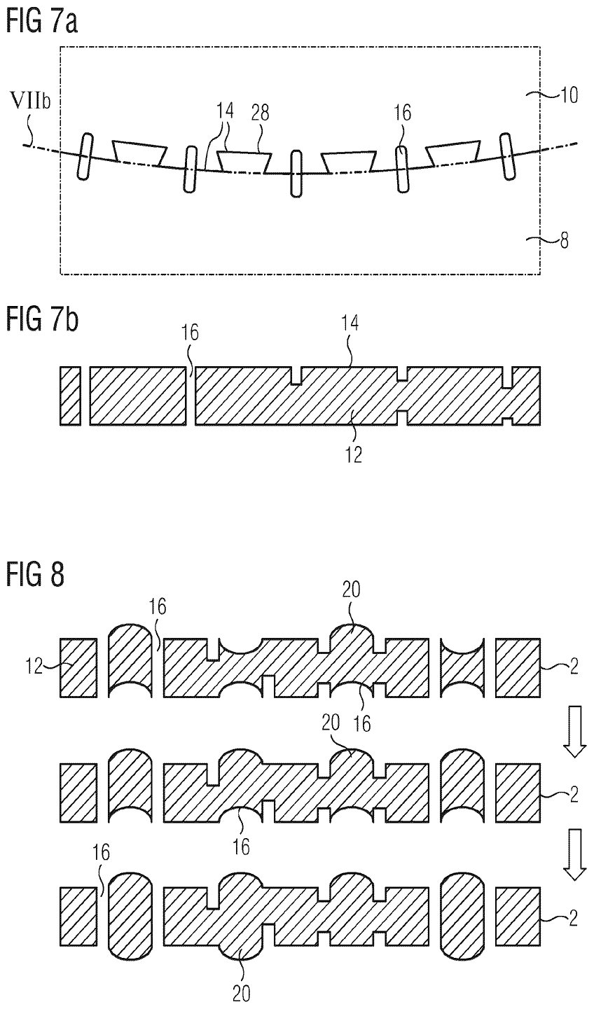

FIG. 7 gives a further analogous diagram to FIGS. 4 to 6, where undercuts 28 of the boundary line 14 are also shown here in addition to the material depression lines 16. These extend from the first material component 8 with the undercut 28 into the second material component 10. The undercuts 28 are a particularly advantageous measure when the undercut is formed by the material component that has the greater coefficient of thermal expansion of the two material components 8, 10. This measure, in the event of contraction of the material component that forms the undercut 28, causes a tensile effect on the respectively other material component 8, 10. An undercut on both sides, in which the undercuts of one particular material component 8 alternate with the other material component 10, is not so convenient as to lead to mutual cancellation of this described tensile effect.

As shown in FIG. 9, the production method for a corresponding magnetic lamination 2 described so far is still to be discussed. For production of the magnetic lamination 2, preference is given to employing a stencil printing method, wherein a template 30 is placed onto the substrate 34 and, by means of a squeegee 32, a print paste (not shown in FIG. 9) is printed onto the substrate. The template 30 has openings through which the print paste is pressed onto the substrate. The openings of the template 30 have preferably been provided with a screen, which is why the method is also frequently referred to as screenprinting.

This printing is effected in the production of a two-component lamination twice with different templates, so as to result in, as shown in FIG. 9b, a two-component green body 36 with the first material component 8 and the second material component 10 on the substrate 34. In a debindering oven 38, this is freed of organic solvents and binders from the print paste, which are decomposed thermally or evaporate. The green body 36 thus created is then introduced into a sintering furnace 40. The temperature in the sintering furnace 40 is a sintering temperature selected such that sinter bonds are formed via diffusion processes between functional particles of the individual material components 8, 10, i.e. in particular metallic particles consisting of the alloy constituents described. The sintering temperatures are temperatures at which melt phases of the individual metallic particles can occur to some degree, but which are below the melting temperature of the metal particles.

The magnetic lamination 2 cooled after the sintering process is then sent to further processing. It is possible here, for example, to introduce the material depression lines 16 by stamping processes. The material elevation lines 20 can be introduced by deformation processes, such that a material depression line 16 is formed on one side of the magnetic lamination 2, and a corresponding material elevation line on the other side.

It should be noted that the material depression lines 16 and the material elevation lines may also already have been introduced in the green body 36. The material elevation lines may be applied to the green body before the sintering process by a further additive method. They may additionally be sprayed on or printed on, for example, by means of a template as well.

### LIST OF REFERENCE SIGNS

2 magnetic lamination
4 laminated core
6 electric machine
8 first material component
10 second material component
12 interface
14 boundary line
16 material depression lines
18 tangent
20 material elevation line
22 center axis
24 rotor
25 stator
26 housing
28 undercut
30 template
32 squeegee
34 substrate
36 green body
38 debindering oven
40 sintering furnace
α running angle

What is claimed is:

1. An additively manufactured rotationally symmetric magnetic lamination for a laminated core of an electric machine, the lamination comprising:
a first material component and a second material component separate from one another in their planar extent;
wherein the material components meet at an interface forming a boundary line when viewed at right angles to a plane of the lamination;
material depression lines in the magnetic lamination run from the first material component over the boundary line to the second material component; and
the running angle α thereof, based on the tangent of the boundary line at which the material depression line intersects the boundary line , is between 45° and 135°.

2. The magnetic lamination as claimed in claim 1, wherein material elevation lines in the magnetic lamination extend from the first material component over the boundary line to the second material component with a
running angle α′ thereof, based on the tangent of the boundary line at which the material elevation line intersects the boundary line is between 45° and 135°.

3. The magnetic lamination as claimed in claim 1, wherein respective material depression lines have varying depths.

4. The magnetic lamination as claimed in claim 1, wherein respective material depression lines have a length between 1 mm and 10 mm.

5. The magnetic lamination as claimed in claim 1, wherein the boundary line is formed by the first material component to form an undercut in the second material component.

6. The magnetic lamination as claimed in claim 1, wherein a course of the boundary line is rotationally symmetric with respect to a center axis of the magnetic lamination.

7. The magnetic lamination as claimed in claim 1, wherein the first material component comprises an iron alloy with an austenitic microstructure of at least 25% by volume.

8. The magnetic lamination as claimed in claim 1, wherein the second material component comprises an iron alloy as of at least 90% iron by weight.

9. The magnetic lamination as claimed in claim 8, wherein the second material component has a ferritic or martensitic microstructure.

10. The magnetic lamination as claimed in claim 1, wherein the first material component comprises a chromium-nickel alloy.

11. The magnetic lamination as claimed in claim 1, wherein the first material component rises an iron-chromium alloy with a chromium content of between 22% by weight and 28% by weight.

12. The magnetic lamination as claimed in claim 11, wherein the first material component has a nickel content of between 4% by weight and 10% by weight.

13. A laminated core for a rotor of an electric machine, the core comprising:
a plurality of magnetic laminations;
each of the magnetic laminations comprising:
first material component and a second material component separate from one another in their planar extent;
wherein the material components meet at an interface forming a boundary line when viewed at right angles to a plane of the lamination;
material depression lines in the magnetic lamination run from the first material component over the boundary line to the second material component; and
the running angle o thereof, based on the tangent of the boundary line at which the material depression line intersects the boundary line, is between 45° and 135°.

14. The laminated core as claimed in claim 13, wherein the plurality of magnetic laminations are stacked so material depression lines of a first magnetic lamination are filled by material elevation lines of a second magnetic lamination.

15. An electric machine comprising:
a laminated core for a rotor of an electric machine, the core comprising a plurality of magnetic laminations;
each of the magnetic laminations comprising:
first material component and a second material component separate from one another in their planar extent;
wherein the material components meet at an interface forming a boundary line when viewed at right angles to a plane of the lamination;
material depression lines in the magnetic lamination run from the first material component over the boundary line to the second material component; and
the running angle o thereof, based on the tangent of the boundary line at which the material depression line intersects the boundary line, is between 45° and 135°.
